(19) United States
(12) Patent Application Publication
(10) Pub. No.: US 2023/0083284 A1
(43) Pub. Date: Mar. 16, 2023

(54) FILTER COEFFICIENT OPTIMIZATION APPARATUS, LATENT VARIABLE OPTIMIZATION APPARATUS, FILTER COEFFICIENT OPTIMIZATION METHOD, LATENT VARIABLE OPTIMIZATION METHOD, AND PROGRAM

(71) Applicant: NIPPON TELEGRAPH AND TELEPHONE CORPORATION, Tokyo (JP)

(72) Inventors: Ryotaro SATO, Tokyo (JP); Kenta NIWA, Tokyo (JP)

(73) Assignee: NIPPON TELEGRAPH AND TELEPHONE CORPORATION, Tokyo (JP)

(21) Appl. No.: 17/802,105

(22) PCT Filed: Feb. 28, 2020
(86) PCT No.: PCT/JP2020/008232

§ 371 Date: Aug. 24, 2022

(51) Int. Cl. G06F 17/15; H04R 1/40; H04R 3/12

(52) U.S. Cl. CPC G06F 17/156; H04R 1/40; H04R 3/12; H04R 2203/12

(57) ABSTRACT

Provided is a technology of optimizing a latent variable by solving a convex optimization problem equivalent to a non-convex optimization problem instead of solving the non-convex optimization problem. A latent variable optimization apparatus includes an optimization unit that calculates an optimum value ˜w* of a latent variable ˜w based on an optimization problem min_{˜w}(L_{convex}(˜w)+Σ_{d=1}^{D}L_{d}(˜w)), L_{convex} being a strongly convex function relevant to the latent variable ˜w, L_{d} being a function relevant to the latent variable ˜w, S_{d,1}, . . . , S_{d,C} being a region that is obtained by dividing a domain of the function L_{d} into C closed convex sets, ∧_{d,c} being a convex function that is defined on the region S_{d,c} and that approximates the function L_{d}, c_{d} being a discrete variable that has a value of 1, . . . , C, the optimization unit calculating the optimum value ˜w* by solving an optimization problem min_{c_1, . . . , c_D} (min_{˜w}(L_{convex} (˜w)+Σ_{d=1}^{D}∧_{d,c_d}(˜w))) instead of solving the above optimization problem.

### TECHNICAL FIELD

The present invention relates to a technology for optimizing a latent variable of a model to be optimized, as exemplified by a filter coefficient in target sound emphasis.

### BACKGROUND ART

A beamforming using a microphone array is well known as a signal processing technique for emphasizing only sound (hereinafter referred to as target sound) that comes from a particular angular direction and suppressing sound (hereinafter referred to as non-target sound) that comes from other angular directions. This technique has been put to practical use in a telephone meeting system, a communication system in an automobile, a smart speaker, and the like.

As an example of the beamformer design technique proposed before now, there is a technique of suppressing the non-target sound while imposing a constraint about the response for a plurality of sound source directions in a situation where sound sources to be emphasized are in a plurality of angular directions. As one of them, there is an LCMV (Linearly Constrained Minimum Variance) beamformer (see Non Patent Literature 1). The LCMV beamformer emphasizes the target sound by imposing an equality constraint to responses of the beamformer for a plurality of angular directions, and suppresses the non-target sound by minimizing the variance of the output signal. A design technique for the LCMV beamformer will be described below in detail.

First, various definitions and notations are introduced. Hereinafter, signals are handled as values in time-frequency region after short-time Fourier transform.

A subscript of a time frame is expressed as t=1, . . . , T, and a subscript of a frequency bin is expressed as f=1, . . . , F. Further, complex conjugate transpositions of a vector v and a matrix M are expressed as a superscript H, as shown by v^{H} and M^{H}.

In the design of the LCMV beamformer, a linear filter (beamformer) that eliminate the non-target sound as unnecessary sound from an observation signal of a microphone array constituted by M microphone elements and emphasizes the target sound as the sound from a plurality of preset angular directions is configured. An observation signal for an M channel of the microphone array in a time frame t and a frequency bin f is shown as x_{f,t}∈C^{M} (f=1, . . . , F, t=1, . . . , T). A situation where D sound sources as signal sources that emit sound exist far off and a virtual plane wave comes to the microphone array is assumed. Further, it is assumed that all sound sources and all microphone elements are on identical planes. A signal that is emitted from a sound source d (d=1, . . . , D) and that comes to the microphone array in the time frame t and the frequency bin f is shown as s_{d,f,t}∈C (d=1, . . . , D, f=1, . . . , F, t=1, . . . , T). It is assumed that the sound of the sound source d comes from an angular direction θ_{d}. It is assumed that the angular direction θd is known.

When an array manifold vector (hereinafter referred to as an array manifold vector in the frequency bin f corresponding to a sound wave as a plane wave that comes from the angular direction θ_{d}) in the frequency bin f from the sound source d to M microphone elements of the microphone array is shown as a_{f,d}∈C^{M} (f=1, . . . , F, d=1, . . . , D), the observation signal x_{f,t}, is expressed by the following expression.

$$\begin{matrix}[ Math . 1 ] & \\ {x}_{f , t} = {{\sum }^{D}}_{d = 1} {s}_{d , f , t} {a}_{f , d} + {n}_{f , t} ⋯ & ( 1 )\end{matrix}$$

Here, n_{f,t} (f=1, . . . , F, t=1, . . . , T) expresses a noise component including noises added in the course of the observation and other echoes and non-directional noises. The array manifold vector a_{f,d} is a quantity that is automatically determined for each frequency bin f from physical characteristics of the microphone array and the whole system.

Hereinafter, a linear filter in the frequency bin f is expressed as w_{f}∈C^{M} (f=1, F), and this is referred to as a filter coefficient of the beamformer. The filter coefficient determines the behavior of the beamformer.

An output signal y_{f,t} (f=1, F, t=1, T) of the beamformer is expressed by the following expression.

[Math. 2]

y_{f,t}=w_{f}^{H}x_{j,t} (2)

That is, the design of the beamformer is the design of a filter coefficient w_{f} (f=1, F) that meets Expression (2).

An inner product w_{f}^{H}a_{f,d} of the filter coefficient w_{f} and the array manifold vector a_{f,d} means a response characteristic of the beamformer in the frequency bin f for the angular direction θ_{d}. Accordingly, in a situation where it is desirable to certainly collect, at a constant gain, the sound that comes from a sound source in the angular direction θ_{d} (that is, from the sound source d), a method of imposing the following constraint condition (referred to as a distortionless constraint condition) on the filter coefficient w_{f} is often used.

[Math. 3]

w_{f}^{H}a_{f,d}=1 (3)

(f=1, . . . , F)

It is possible to achieve the emphasis of the sound that comes from the sound source d, by setting the filter coefficient w_{f} such that the distortionless constraint condition is met and gains for signals from unnecessary sound sources are reduced as much as possible.

In the case where it is desirable to concurrently emphasize the sound that comes from a plurality of sound sources, it is only necessary to concurrently impose a plurality of distortionless constraint conditions.

Since the beamformer is required to suppress the non-target sound, it is desired to set the filter coefficient w_{f} such that the non-target sound is minimized under the constraint of the target sound emphasis. For mathematically formulating this, a cost function expressing the variance of the non-target sound is defined. It is expected that it is possible to design a desired beamformer by setting the filter coefficient such that the cost function is minimized.

When a spatial correlation matrix R_{f} (f=1, F) of the non-target sound is defined as R_{f}:=Eₜ[x_{f,t}x_{f,t}^{H}], a cost function L_{MV_f}(w_{f}) expressing the variance of the non-target sound can be defined for each of the frequency bins f=1, F. Specifically, the cost function L_{MV_f}(w_{f}) is shown as the following expression.

[Math. 4]

L_{MV}_{_{f}}(w_{f}):=w_{f}^{H}R_{f}w_{f} (4)

It is possible to design the beamformer by setting the filter coefficient w_{f} (f=1, F) such that the sum of the cost function L_{MV_f}(w_{f}) is minimized under the constraint condition in Expression (3). When this is expressed as a mathematical expression, an optimization problem in the following expression is obtained.

$$\begin{matrix}[ Math . 5 ] & \\ {min}_{{w}_{1} , ⋯ , {w}_{F}} {\sum }_{f} {L}_{{MV}_{f}} ( {w}_{f} ) \\ s . t . {w}_{f}^{H} {a}_{f , d} = 1 ( f = 1 , ⋯ , F , d = 1 , ⋯ , D ) ⋯ & ( 5 )\end{matrix}$$

By solving the optimization problem in Expression (5), it is possible to obtain the optimum filter coefficient.

The optimization problem in Expression (5) can be divided into individual optimization problems for the respective frequency bins f=1, . . . , F. That is, for the frequency bin f, an optimization problem in the following expression may be solved instead of the optimization problem in Expression (5).

$$\begin{matrix}[ Math . 6 ] & \\ {min}_{{w}_{f}} {L}_{{MV}_{f}} ( {w}_{f} ) & ( 6 )\end{matrix}$$

$$s . t . {w}_{f}^{H} {a}_{f , d} = 1 ( d = 1 , … , D )$$

By solving the optimization problem in Expression (5) or Expression (6) described above, it is possible to design the LCMV beamformer. This is the conventional design technique for the LCMV beamformer.

### CITATION LIST

### Non-Patent Literature

Non-Patent Literature 1: Futoshi Asano, “Acoustic Technology Series 16, Array signal processing for acoustics: localization, tracking and separation of sound sources, edited by The Acoustical Society of Japan”, Corona Publishing Co., Ltd., pp. 86-90, 2011.

### SUMMARY OF THE INVENTION

### Technical Problem

In the conventional design technique for the LCMV beamformer, by the constraint condition in Expression (3), a strict constraint is imposed on both of the amplitude (that is, the amplitude ratio of an output signal to an input signal) and phase (that is, the phase delay of the output signal to the input signal) of the response of the beamformer. Therefore, in the optimization problem in Expression (5) or Expression (6), that is, in the problem of evaluating the filter coefficient that minimizes the cost function Σ_{f}L_{MV__f} (w_{f}) or the cost function L_{MV_f} (w_{f}) in a range in which the condition of “s.t. . . . ” is met, there is a problem in that when the number of constraint conditions in Expression (3) is excessively large, the range of the value that the filter coefficient can have is significantly restricted and it is difficult to evaluate the filter coefficient that can suppress the non-target sound.

For resolving this problem, it is conceivable to adopt a method of avoiding a situation where there is no solution for the optimization problem, by introducing a softer cost function or constraint condition instead of the constraint condition in Expression (3). However, in this case, by relaxing the form of the cost function and the constraint condition, the optimization problem that should be solved in the design of the beamformer mathematically becomes a non-convex optimization problem, so that it is sometimes difficult to solve the optimization problem.

Hence, the present invention has an object to provide a technology of optimizing the latent variable by solving the convex optimization problem equivalent to the non-convex optimization problem instead of solving the non-convex optimization problem.

### Means for Solving the Problem

An aspect of the present invention is a filter coefficient optimization apparatus including an optimization unit that calculates an optimum value w* of a filter coefficient w={w₁, . . . , w_{F}} (w_{f} (f=1, . . . , F, F is an integer equal to or more than 1) is a filter coefficient of a frequency bin f) of a beamformer that emphasizes sound (hereinafter referred to as target sound) from D sound sources (hereinafter referred to as a sound source 1, . . . , a sound source D), D being an integer equal to or more than 1, R_{f} (f=1, . . . , F) being a spatial correlation matrix for sound other than the target sound relevant to the frequency bin f, L_{MV_f}(w_{f})=w_{f}^{H}R_{f}w_{f} (f=1, . . . , F) being a cost function relevant to a filter coefficient w_{f}, the optimization unit calculating the optimum value w* based on an optimization problem min_{w_1}, . . . ,_{W_F}Σ_{f=i}^{F}L_{MV_f} (w_{f}) relevant to the filter coefficient w under a predetermined constraint condition, the predetermined constraint condition not including a constraint relevant to a phase of the filter coefficient w_{f} (f=1, . . . , F).

An aspect of the present invention is a latent variable optimization apparatus including an optimization unit that calculates an optimum value ˜w* of a latent variable ˜w based on an optimization problem Min_{˜w} (L_{convex} (˜W)+Σ_{d=1}^{D}L_{d} (˜W)) relevant to the latent variable ˜w, L_{convex} being a strongly convex function relevant to the latent variable ˜w, L_{d} (d=1, . . . , D, D is an integer equal to or more than 1) being a function relevant to the latent variable ˜w, C being an integer equal to or more than 1, S_{d,1}, . . . , S_{d,C} (d=1, . . . , D) being a region that is obtained by dividing a domain of the function L_{d} into C closed convex sets, ∧_{d,c} (d=1, . . . , D, c=1, . . . , C) being a convex function that is defined on the region S_{d,c} and that approximates the function L_{d}, c_{d} (d=1, . . . , D) being a discrete variable that has a value of 1, . . . , C, the optimization unit calculating the optimum value ˜w* by solving an optimization problem min_{c_1, . . . , c_D} (min-_{w} (L_{convex} (˜w)+Σ_{d=1}^{D}∧_{d,c_d} (˜w))) relevant to the latent variable ˜w and the discrete variable c₁, . . . r C_{D} instead of solving the optimization problem min_{˜w} (L_{convex} (˜w)+Σ_{d=1}^{D}L_{d} (˜w)).

### Effects of the Invention

According to the present invention, it is possible to optimize the latent variable, by solving the convex optimization problem equivalent to the non-convex optimization problem instead of solving the non-convex optimization problem.

### BRIEF DESCRIPTION OF DRAWINGS

FIG. 1 is a diagram showing a latent variable optimization algorithm.

FIG. 2A is a diagram showing a manner of the approximation by a piecewise convex function.

FIG. 2B is a diagram showing a manner of the approximation by the piecewise convex function.

FIG. 2C is a diagram showing a manner of the approximation by the piecewise convex function.

FIG. 2D is a diagram showing a manner of the approximation by the piecewise convex function.

FIG. 3 is a diagram showing a filter coefficient optimization algorithm.

FIG. 4 is a block diagram showing the configuration of a filter coefficient optimization apparatus 100 (latent variable optimization apparatus 100).

FIG. 5 a flowchart showing the behavior of the filter coefficient optimization apparatus 100 (latent variable optimization apparatus 100).

FIG. 6 is a block diagram showing the configuration of an optimization unit 120.

FIG. 7 is a flowchart showing the behavior of the optimization unit 120.

FIG. 8 is a diagram showing an example of the functional configuration of a computer that realizes apparatuses in embodiments of the present invention.

### DESCRIPTION OF EMBODIMENTS

Embodiments of the present invention will be described below in detail. Component units having identical functions are denoted by identical numerals, and repetitive descriptions are omitted.

Before the description of the embodiments, the notation method in the specification will be described.

“_” (underscore) indicates an inferior subscript. For example, “x^{y_z}” shows that “y_{z}” is a superscript for “x”, and “x_{y_z}” shows that “y_{z}” is an inferior subscript for “x”.

Further, for a certain character “x”, superscripts “∧” and “˜” for “∧x” and “˜x” should be originally put just above “x”, but “∧x” and “˜x” are shown because of the constraint about the notation in the specification.

### TECHNICAL BACKGROUND

First, a method of transforming a non-convex optimization problem into a convex optimization problem equivalent to the non-convex optimization problem and a method of solving the convex optimization problem obtained by the transformation will be described. Next, an example in which the method is applied to a non-convex optimization problem obtained by relaxing the constraint condition in Expression (3) will be described. Finally, an application example other than the sound source emphasis will be described.

«Transformation into Convex Optimization Problem Equivalent to Non-Convex Optimization Problem and Solution Method»

Here, a method for transforming the non-convex optimization problem into the convex optimization problem equivalent to the non-convex optimization problem and a method for solving the convex optimization problem obtained by the transformation will be described. An optimization problem relevant to a latent variable ˜w that is defined by the following expression will be discussed below.

$$\begin{matrix}[ Math . 7 ] & \\ {min}_{\tilde{w}} ( {L}_{convex} ( \tilde{w} ) + {\sum }_{d = 1}^{D} {L}_{d} ( \tilde{w} ) ) & ( 7 )\end{matrix}$$

Here, L_{convex} is a strongly convex function relevant to the latent variable ˜w, and L_{d} (d=1, . . . , D, D is an integer equal to or more than 1) is a function relevant to the latent variable ˜w. That is, L_{d} (d=1, . . . , D) does not always need to be a convex function.

Generally, the optimization problem in Expression (7) is an optimization problem in which the cost function is a non-convex function, that is, a non-convex optimization problem. The non-convex optimization problem is a difficult problem as described above, and therefore, is intended to result in a convex optimization problem to be solved more easily, by introducing a certain kind of approximation. Hence, the function L_{d}(˜w) (d=1, . . . , D) is intended to be approximated by a piecewise convex function constituted by a plurality of convex functions.

The definition of the piecewise convex function will be described below. For the function L_{d}(˜w) (d=1, . . . , D) to be approximated, the domain is divided into regions S_{d,1}, . . . , S_{d,C} that are C closed convex sets. Then, a function ∧_{d,c} (c=1, . . . , C) that is defined for each of the regions S_{d,1}, . . . , S_{d,c} is introduced. The newly introduced function ∧_{d,c} is a convex function on the region S_{d,c}, and is a function for approximating the function L_{d} on the region S_{d,c}. In the case where the function L_{d} is a convex function on the region S_{d,c}, ∧_{d,c}=L_{d} may be adopted on the region S_{d,c}. Thereby, the function L_{d}(˜w) can be approximately expressed by the piecewise convex function ∧_{d,c} (c=1, . . . , C). Generally, as the value (that is, the number into which the domain of the function L_{d} is divided) of C is larger, the approximation can be performed by a more accurate piecewise convex function.

However, when the approximation is used, a discrete variable representing a region to which the optimum value as the solution of the optimization problem belongs is newly added as an optimized object, in addition to the latent variable that is an optimized object in the optimization problem in Expression (7), so that the number of variables to be optimized increases. However, when the discrete variable is fixed, for the latent variable, the optimization problem results in the convex optimization (instead of the non-convex optimization), and therefore can be solved relatively easily. This will be specifically described below. The optimization problem that is formulated using the approximation is expressed by the following expression, with c_{d} (d=1, . . . , D) as a discrete variable that has a value of 1, . . . , C.

$$\begin{matrix}[ Math . 8 ] & \\ {min}_{\tilde{w}} ( {L}_{convex} ( \tilde{w} ) + {\sum }_{d = 1}^{D} {min}_{{c}_{d}} {Λ}_{d , {c}_{d}} ( \tilde{w} ) ) & ( 8 )\end{matrix}$$

Expression (8) is equivalent to the following expression.

$$\begin{matrix}[ Math . 9 ] & \\ {min}_{{c}_{1} , … , {c}_{D}} ( {min}_{\tilde{w}} ( {L}_{convex} ( \tilde{w} ) + {\sum }_{d = 1}^{D} {Λ}_{d , {c}_{d}} ( \tilde{w} ) ) ) & ( 9 )\end{matrix}$$

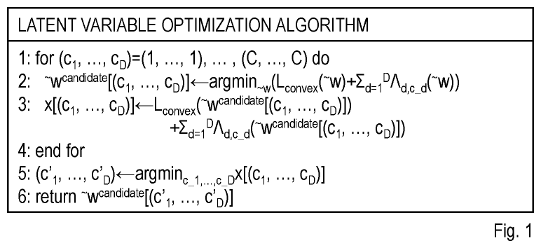

In Expression (9), min_{˜w} (L_{convex}(˜w)+Σ_{d=1}^{D}∧_{d,c_d}(˜w)) is a convex optimization problem relevant to the latent variable ˜w, and can be solved relatively easily. The procedure will be described below. First, the convex optimization problem Min_{˜w} (L_{convex} (˜W)+Σ_{d=1}^{D}∧_{d,c_d} (˜w)) is solved for all values that the discrete variable (c₁, . . . , c_{D}) can have. Thereby, the solution of the convex optimization problem min_{˜w} (L_{convex} (˜w)+Σ_{d=1}^{D}∧_{d,c_d} (˜w)) is evaluated for all values that the C^{D} discrete variables (c₁, . . . , C_{D}) can have. Then, among the obtained solutions of the convex optimization problem, a solution that minimizes the value the cost function L_{convex}(˜w)+Σ_{d=1}^{D}∧_{d,c_d}(˜w) is adopted as the optimum value. Thereby, the optimization problem in Expression (9) can be solved. The procedure of the solution method is illustrated in FIG. 1.

The non-convex optimization problem in Expression (7) can be transformed into the convex optimization problem in Expression (9) that is equivalent to the non-convex optimization problem in Expression (7), and the convex optimization problem in Expression (9) can be solved by the latent variable optimization algorithm in FIG. 1.

<<Application Example>>

Here, an example in which the above-described versatile scheme of evaluating the optimum value after transforming the non-convex optimization problem into the convex optimization problem is applied to the non-convex optimization problem obtained by relaxing the constraint condition in Expression (3) will be described.

As described above, in the related art in Non Patent Literature 1, Expression (3) that is an equality constraint is imposed for many objects, and therefore, there is a fear that an appropriate filter coefficient cannot be obtained. Hence, it is intended to use a softer constraint condition that is suitable for a real situation. Specifically, it is intended to use a constraint condition (that is, a constraint condition in which there is no constraint relevant to the phase) in which a constraint is imposed for only the amplitude of the response of the beamformer, instead of the constraint condition in Expression (3). For example, the following expression can be used.

[Math. 10]

|w_{f}^{H}a_{f,d}|=1 (10)

Further, as another example, the following expression can be used.

[Math. 11]

|w_{f}^{H}a_{f,d}|≥1 (11)

The constraint condition in Expression (10) and the constraint condition in Expression (11) express the constraint that the amplitude of the response of the beamformer is a constant value (specifically, 1) and the constraint that the amplitude of the response of the beamformer only needs to be equal to or more than a constant value (specifically, 1), respectively. Each of the constraint condition in Expression (10) and the constraint condition in Expression (11) is mathematically classified into a non-convex constraint.

An optimization problem in which the constraint condition is Expression (11) will be discussed below. The constraint condition in Expression (11) shows that the absolute value of the complex number w_{f}^{H}a_{f,d} is equal to or more than 1. This means that the complex number w_{f}^{H}a_{f,d} needs to be geometrically positioned on a unit circle or outside the unit circle in the complex plane. Hence, first, the complex plane is equally divided into C sectors that are around the origin. The C sectors correspond to the C regions described above. Then, on the border or inside of each sector, Expression (11) that is the original constraint is approximated by C convex functions.

This will be specifically described below. The discrete variable c_{f,d} is adopted as a variable that has a value of 1, . . . , C, for the frequency bin f (f=1, . . . , F) and the sound source d (d=1, . . . , D). Further, γ_{f,d}=w_{f}^{H}a_{f,d} is satisfied. A convex function ∧_{(f,d),c_f,d}(γ_{f,d}) (C_{f,d}=1, . . . , C) that is defined for the frequency bin f (f=1, . . . , F) and the sound source d (d=1, . . . , D) is defined such that the values of the complex number γ_{f,d} are restricted inside the sectors around the origin at a central angle 2n/C on the complex plane and in a range in which |γ_{f,d}|≥1 is met.

For example, the function ∧_{(f,d),c_f,d} may be a function expressed by the following expression.

$$\begin{matrix}[ Math . 12 ] & \\ {Λ}_{( f , d ) , {c}_{f , d}} ( {γ}_{f , d} ) := \{ \begin{matrix}0 ( R ( {γ}_{f , d} {e}^{- 2 π j ( {c}_{f , d} + 1 ) / 2 C} ) \geq 1 , \frac{2 π {c}_{f , d}}{C} \leq {∠γ}_{f , d} \leq \frac{2 π ( {c}_{f , d} + 1 )}{C} ) \\ ∞ ( otherwise )\end{matrix} & ( 12 )\end{matrix}$$

Here, R(z) represents the real part of a complex number z.

Further, Expression (11) is approximated by a piecewise convex function using C convex functions ∧_{(f,d),c_f,d} (γ_{f,d}) (C_{f,d}=1, . . . , C).

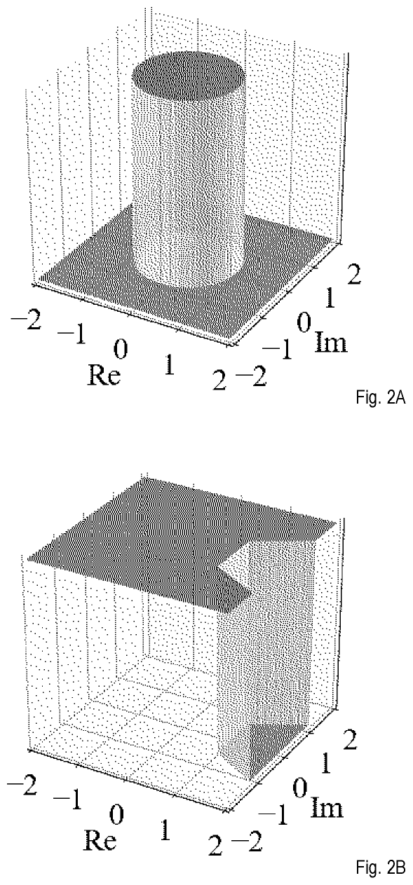

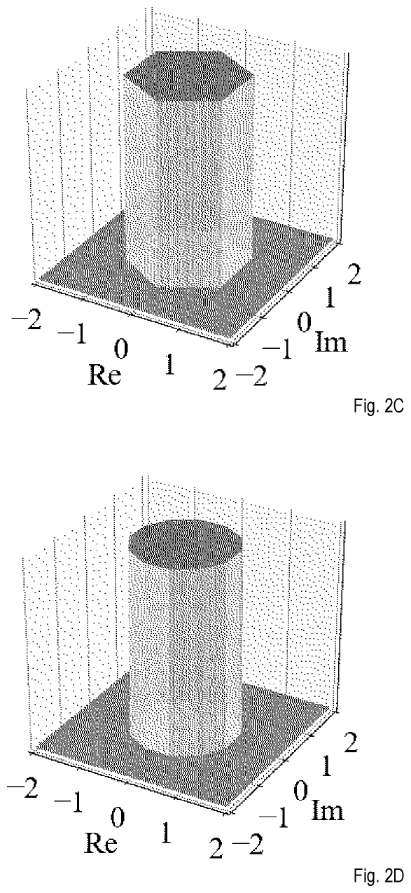

FIG. 2A, FIG. 2B, FIG. 2C and FIG. 2D are diagrams showing manners in which Expression (11) is approximated by the C convex functions ∧_{(f,d),c_f,d}(γ_{f,d}). FIG. 2A illustrates the constraint condition in expression (11) on a complex plane, and shows an approximated object. FIG. 2B illustrates an example of the convex function ∧_{(f,d),c_f,d}(γ_{f,d}) introduced for the approximation. FIG. 2C and FIG. 2D illustrate minimum values Min_{c_f,d=1, . . . ,C}∧_{(f,d),c_f,d}(γ_{f,d}), in which FIG. 2C is a diagram showing the case of C=6 and FIG. 2D is a diagram showing the case of C=10.

When the value of C is large, the approximation can be performed more accurately, but in the case of solving the optimization problem using the algorithm in FIG. 1, it is necessary to examine all combinations of the discrete variables, so that the calculation amount increases.

Thus, the filter coefficient optimization problem in which the constraint condition is Expression (11) results in a convex optimization problem in the following expression.

$$\begin{matrix}[ Math . 13 ] & \\ {min}_{{\{ {c}_{f} , {w}_{f} \}}_{f = 1}^{F}} ( {\sum }_{f = 1}^{F} {L}_{{MV}_{f}} ( {w}_{f} ) + {\sum }_{f = 1}^{F} {\sum }_{d = 1}^{D} {Λ}_{( f , d ) , {c}_{f , d}} ( {w}_{f}^{H} {a}_{f , d} ) ) & ( 13 )\end{matrix}$$

Here, c_{f}=(c_{f,1}, . . . , c_{f,D}) is satisfied.

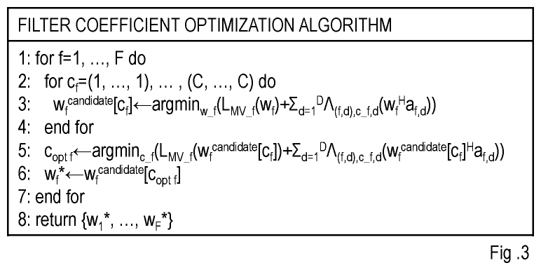

This optimization problem can be solved by applying the latent variable optimization algorithm in FIG. 1. An algorithm for solving the optimization problem is shown in FIG. 3. That is, FIG. 3 shows a filter coefficient optimization algorithm that is obtained based on the latent variable optimization algorithm in FIG. 1.

<<Application to Local Reproduction System>>

Another application example will be described. Specifically, a local reproduction system using many speakers will be described.

Suppose that a local reproduction system in which there are K omnidirectional speakers in a space and in which among N+M sound receiving points, sound is reproduced at the N points in the first part and sound is not leaked at the M points in the second part is configured. Therefore, a signal process of convoluting a linear filter in a 1 ch sound source and reproducing sound from each speaker is performed.

Similarly to the above description, the time-frequency region will be discussed. As for the N points where sound is reproduced, an array manifold vector from the K omnidirectional speakers to a point i (i=1, N) in the frequency bin f is shown as a_{f,i}∈C^{K}. Further, as for the M points where sound is not leaked, an array manifold vector from the K omnidirectional speakers to a point j (j=1, . . . , M) in the frequency bin f is shown as b_{f,i}∈C^{K}. Further, a filter coefficient to be designed is shown as w_{f} (f=1, . . . , F).

As for the point i (i=1, N) where sound is reproduced, it is desirable that the amplitude of the response w_{f}^{H}a_{f,i} in the frequency bin f at the point i is equal to or more than a constant value. On the other hand, as for the point j (j=1, M) where sound is expected not to be leaked, it is desirable that the amplitude of the response w_{f}^{H}b_{f,j} in the frequency bin f at the point j is as small as possible. Accordingly, the optimization problem of the filter coefficient is formulated by the following expression.

$$\begin{matrix}[ Math . 14 ] & \\ {min}_{{w}_{1} , … , {w}_{F}} {\sum }_{f = 1}^{F} {\sum }_{j = 1}^{M} {\vert {w}_{f}^{H} {b}_{f , j} \vert}^{2} s . t . \vert {w}_{f}^{H} {a}_{f , i} \vert \geq 1 ( f = 1 , … , F , i = 1 , … , N ) & ( 14 )\end{matrix}$$

The optimization problem in Expression (14) can be solved by the same algorithm as the algorithm in FIG. 3, and therefore, a desired local reproduction system can be designed.

### First Embodiment

From a signal (observation signal) resulting from observing sound (hereinafter referred to as target sound) from D sound sources (hereinafter referred to as a sound source 1, . . . , a sound source D), a filter coefficient optimization apparatus 100 calculates the optimum value w* of the filter coefficient w={w₁, . . . , w_{F}} of the beamformer that emphasizes the target sound, using a microphone array constituted by M microphone elements. Here, M is an integer equal to or more than 1. D is an integer equal to or more than 1. Further, w_{f} (f=1, . . . , F, F is an integer equal to or more than 1) is the filter coefficient of the frequency bin f. The observation signal is an input data that is used for the optimization of the filter coefficient, and therefore, the observation signal is referred to as optimization data, hereinafter.

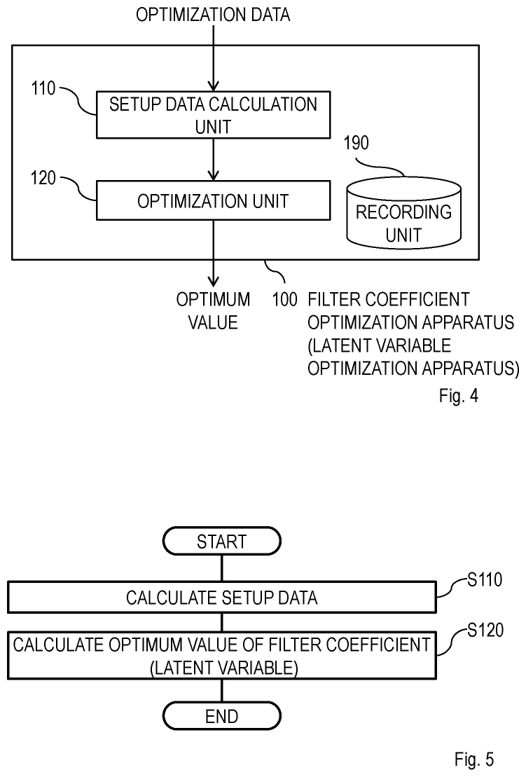

The filter coefficient optimization apparatus 100 will be described below with reference to FIG. 4 and FIG. 5. FIG. 4 is a block diagram showing the configuration of the filter coefficient optimization apparatus 100. FIG. 5 is a flowchart showing the behavior of the filter coefficient optimization apparatus 100. As shown in FIG. 4, the filter coefficient optimization apparatus 100 includes a setup data calculation unit 110, an optimization unit 120, and a recording unit 190. The recording unit 190 is a component unit that appropriately records the information necessary for the processing in the filter coefficient optimization apparatus 100. For example, the recording unit 190 records the filter coefficient that is an optimized object.

The behavior of the filter coefficient optimization apparatus 100 will be described with FIG. 5.

In S110, the setup data calculation unit 110 calculates setup data that is used at the time of the optimization of the filter coefficient w, using the optimization data. In the case of using the cost function for optimizing the filter coefficient w, examples of the setup data include a spatial correlation matrix R_{f} (f=1, . . . , F) for sound other than the target sound relevant to the frequency bin f and the array manifold vector a_{f,d} (f=1, . . . , F, d=1, . . . , D) in the frequency bin f corresponding to a sound wave as a plane wave that comes from the angular direction θ_{d} (d=1, . . . , D) in which the sound source d exists obtained based on the observation signal.

In S120, the optimization unit 120 calculates the optimum value w* of the filter coefficient w, using the setup data generated in S110. For example, the optimization unit 120 can calculate the optimum value w* based on the optimization problem min_{w_1}, . . . ,_{w_F}Σ_{f=1}^{F}L_{MV_f}(w_{f}) relevant to the filter coefficient w under the constraint condition that the constraint relevant to the phase of the filter coefficient w_{f} (f=1, F) is not included. Here, L_{MV_f}(w_{f})=w_{f}^{H}R_{f}w_{f} (f=1, F) is a cost function relevant to the filter coefficient w_{f}. Further, Σ_{f=1}^{F}L_{MV_f}(w_{f}) is referred to as a cost function relevant to the filter coefficient w.

An example of the constraint condition that the constraint relevant to the phase of the filter coefficient w_{f} (f=1, F) is not included is expressed by the following expression.

[Math. 15]

|W_{f}^{H}a_{f,d}|=1

(f=1, F, d=1, . . . ,D)

Further, another example of the constraint condition is expressed by the following expression.

[Math. 16]

|w_{f}^{H}a_{f,d}|≥1 . . . (*)

(f=1, F, d=1, D)

The optimization unit 120 may calculates the optimum value w*, by solving an optimization problem min_{{c_f,w_f}} (Σ_{f=1}^{F}L_{MV_f} (w_{f})+Σ_{f=1}^{F}Σ_{d=1}^{D}∧_{(f,d),c_f,d}(w_{f}^{H}a_{f,d})) relevant to the filter coefficient w and the discrete variable c₁, . . . , c_{F} instead of solving the optimization problem min_{w_1, . . . , W_F}Σ_{f=1}^{F}L_{MV_f}(w_{f}) under the constraint condition (*). Here, C is an integer equal to or more than 1, c_{f,d} (f=1, . . . , F, d=1, . . . , D) is a discrete variable that has a value of 1, . . . , C, c_{f}=(c_{f,1}, c_{f,D}) (f=1, . . . , F) is a discrete variable that is defined by the discrete variable c_{f,1}, . . . , c_{f,D}, and a function ∧_{(f,d),c_f,d} (f=1, F, d=1, D) is a function relevant to a variable γ_{f,d} that is defined by the following expression (γ_{f,d}=w_{f}^{H}a_{f,d}).

$$\begin{matrix}[ math . 17 ] & \\ {Λ}_{( f , d ) , {c}_{f , d}} ( {γ}_{f , d} ) = \{ \begin{matrix}0 ( R ( {γ}_{f , d} {e}^{- 2 π j ( {c}_{f , d} + 1 ) / 2 C} ) \geq 1 , \frac{2 π {c}_{f , d}}{C} \leq {∠γ}_{f , d} \leq \frac{2 π ( {c}_{f , d} + 1 )}{C} ) \\ ∞ ( otherwise )\end{matrix} & \end{matrix}$$

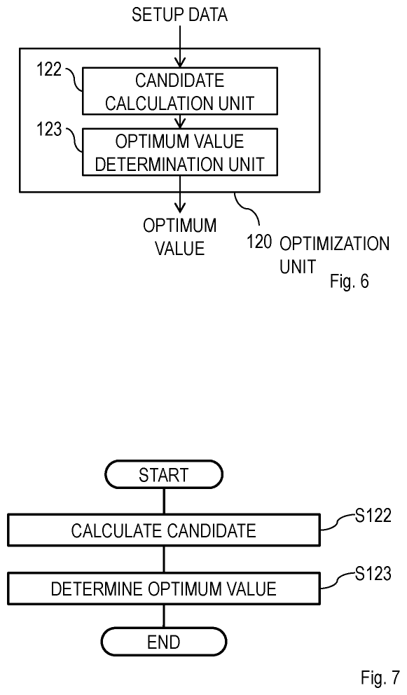

The optimization unit 120 for solving the optimization problem min_{{c_f,w_f}} (Σ_{f=1}^{F}L_{MV_f} (w_{f})+Σ_{f=1}^{F}Σ_{d=1}^{D}∧_{(f,d),c_f,d} (w_{f}^{H}a_{f,d})) will be described below with reference with FIG. 6 and FIG. 7. FIG. 6 is a block diagram showing the configuration of the optimization unit 120. FIG. 7 is a flowchart showing the behavior of the optimization unit 120. As shown in FIG. 6, the optimization unit 120 includes a candidate calculation unit 122 and an optimum value determination unit 123.

The behavior of the optimization unit 120 will be described with FIG. 7.

In S122, the candidate calculation unit 122 calculates a candidate W_{f}^{candidate}[(c_{f,1}, . . . , C_{fj}p)] of the optimum value of the filter coefficient w_{f} for all values that the discrete variable (c_{f,1}, . . . , c_{f,D}) can have, for each frequency bin f, by the following expression.

$$\begin{matrix}[ Math . 18 ] & \\ {w}_{f}^{candidate} [ ( {c}_{f , 1} , … , {c}_{f , D} ) ] ← {arg min}_{{w}_{f}} ( {L}_{{MV}_{f}} ( {w}_{f} ) + {\sum }_{d = 1}^{D} {Λ}_{( f , d ) , {c}_{f , d}} ( {w}_{f}^{H} {a}_{f , d} ) ) & \end{matrix}$$

In S123, the optimum value determination unit 123 adopts a candidate that is of the candidate w_{f} candidate r c_{f,D})] calculated in S122 and that minimizes the value of the cost function L_{MV_f} (w_{f})+Σ_{d=1}^{D}∧_{(f,d),c_f,d}(wₜ^{H}a_{f,d}) as the optimum value W_{f}*, for each frequency bin f, and obtains the optimum value w* from w*={w₁*, . . . , w_{F}*}.

According to the embodiment of the present invention, it is possible to optimize the filter coefficient by solving the convex optimization problem equivalent to the non-convex optimization problem instead of solving the non-convex optimization problem.

### Second Embodiment

Here, a general embodiment for solving the convex optimization problem equivalent to the non-convex optimization problem will be described.

A latent variable optimization apparatus 100 calculates an optimum value ˜w* of a latent variable ˜w from the optimization data. The optimization data is input data that is used for the optimization of the latent variable, or is a combination of input data and output data that are used for the optimization of the latent variable.

The latent variable optimization apparatus 100 calculates the optimum value ˜w* based on an optimization problem min_{˜w}(L_{convex}(˜w)+Σ_{d=1}^{p}L_{d}(˜w)) (L_{convex} is a strongly convex function relevant to the latent variable ˜w, and L_{d} (d=1, . . . , D, D is an integer equal to or more than 1) is a function relevant to the latent variable ˜w) relevant to the latent variable ˜w. For example, the latent variable optimization apparatus 100 calculates the optimum value ˜w* by solving a optimization problem min_{c_1, . . . , c_D}(min_{˜w}(L_{convex}(˜w)+Σ_{d=1}^{D}∧_{d,c_d}(˜w))) relevant to the latent variable ˜w and the discrete variable c₁, . . . , C_{D} instead of solving the optimization problem min_{˜w}(L_{convex}(˜w)+Σ_{d=1}^{D}L_{d}(˜w)). Here, C is an integer equal to or more than 1, S_{d,1}, . . . , S_{d,C} (d=1, . . . , D) is a region that is obtained by dividing a domain of the function L_{d} into C closed convex sets, and a function ∧_{d,c} (d=1, . . . , D, c=1, . . . , C) is a convex function that is defined on the region S_{d,c} and that approximates the function L_{d}. Further, a variable c_{d} (d=1, . . . , D) is a discrete variable that has a value of 1, . . . , C.

The latent variable optimization apparatus 100 will be described below with reference to FIG. 4 and FIG. 5. FIG. 4 is a block diagram showing the configuration of the latent variable optimization apparatus 100. FIG. 5 is a flowchart showing the behavior of the latent variable optimization apparatus 100. As shown in FIG. 4, the latent variable optimization apparatus 100 includes a setup data calculation unit 110, an optimization unit 120 and a recording unit 190. The recording unit 190 is a component unit that appropriately records the information necessary for the processing in the latent variable optimization apparatus 100. For example, the recording unit 190 records the latent variable that is an optimized object.

The behavior of the latent variable optimization apparatus 100 will be described with FIG. 5.

In S110, the setup data calculation unit 110 calculates setup data that is used at the time of the optimization of the latent variable ˜w, using the optimization data. For example, the setup data is each parameter that is used in the optimization problem min_{c_1, . . . , c_D} (min_{˜w}(L_{convex} (˜w)+Σ_{d=1}^{D}∧_{d,c_d} (˜w))).

In S120, the optimization unit 120 calculates the optimization value ˜w* of the latent variable ˜w, using the setup data generated in S110.

The optimization unit 120 will be described below with reference to FIG. 6 and FIG. 7. FIG. 6 is a block diagram showing the configuration of the optimization unit 120. FIG. 7 is a flowchart showing the behavior of the optimization unit 120. As shown in FIG. 6, the optimization unit 120 includes a candidate calculation unit 122 and an optimum value determination unit 123.

The behavior of the optimization unit 120 will be described with FIG. 7.

In S122, the candidate calculation unit 122 calculates the candidate ˜w^{candidate} [(c₁, . . . , c_{D})] of the optimum value of the latent variable ˜w, for all values that the discrete variable (c₁, . . . , c_{D}) can have, by the following expression.

$$\begin{matrix}[ Math . 19 ] & \\ {\tilde{w}}^{candidate} [ ( {c}_{1} , … , {c}_{D} ) ] ← {arg min}_{\tilde{w}} ( {L}_{convex} ( \tilde{w} ) + {\sum }_{d = 1}^{D} {Λ}_{d , {c}_{d}} ( \tilde{w} ) ) & \end{matrix}$$

In S123, the optimum value determination unit 123 adopts a candidate that is of the candidate ˜w^{candidate}[(c₁, . . . , c_{D})] calculated in S122 and that minimizes the value of the cost function L_{convex}(˜w)+Σ_{d=1}^{D}∧_{d,c_d}(˜w), as the optimum value ˜w*.

According to the embodiment of the present invention, it is possible to optimize the latent variable by solving the convex optimization problem equivalent to the non-convex optimization problem instead of solving the non-convex optimization problem.

### Third Embodiment

A filter coefficient optimization apparatus 100 calculates the optimum value w* of the filter coefficient w={w₁, . . . , W_{F}} of a local reproduction system that is configured using K omnidirectional speakers, that reproduces sound at N points of N+M preset points, and that does not leak sound at M points. Here, K is an integer equal to or more than 1. N and M are integers equal to or more than 1. Further, w_{f} (f=1, . . . , F, F is an integer equal to or more than 1) is the filter coefficient of the frequency bin f. The optimization data is input data that is used for the optimization of the latent variable, or is a combination of input data and output data that are used for the optimization of the latent variable.

The filter coefficient optimization apparatus 100 will be described below with reference to FIG. 4 and FIG. 5. FIG. 4 is a block diagram showing the configuration of the filter coefficient optimization apparatus 100. FIG. 5 is a flowchart showing the behavior of the filter coefficient optimization apparatus 100. As shown in FIG. 4, the filter coefficient optimization apparatus 100 includes a setup data calculation unit 110, an optimization unit 120 and a recording unit 190. The recording unit 190 is a component unit that appropriately records the information necessary for the processing in the filter coefficient optimization apparatus 100. For example, the recording unit 190 records the filter coefficient that is an optimized object.

The behavior of the filter coefficient optimization apparatus 100 will be described with FIG. 5.

In S110, the setup data calculation unit 110 calculates setup data that is used at the time of the optimization of the filter coefficient w, using the optimization data. In the case of using the cost function for optimizing the filter coefficient w, examples of the setup data include an array manifold vector a_{f,1} (f=1, . . . , F, i=1, . . . , N) from the K omnidirectional speakers to the point i (i=1, . . . , N) in the frequency bin f and an array manifold vector b_{f,1} (f=1, . . . , F, j=1, . . . , M) from the K omnidirectional speakers to the point j (j=1, . . . , M) in the frequency bin f.

In S120, the optimization unit 120 calculates the optimum value w* of the filter coefficient w, using the setup data generated in S110. For example, the optimization unit 120 can calculate the optimum value w*, based on an optimization problem min_{w_1, . . . ,w_F}Σ_{f=1}^{F}Σⱼ₌₁^{M}|w_{f}^{H}b_{f,j}|² relevant to the filter coefficient w under the constraint condition that the constraint relevant to the phase of the filter coefficient w_{f} (f=1, . . . , F) is not included. Here, Σ_{f=1}^{F}|Σⱼ₌₁^{M}|w_{f}^{H}b_{f,j}|² is referred to as a cost function relevant to the filter coefficient w.

An example of the constraint condition that the constraint relevant to the phase of the filter coefficient w_{f} (f=1, . . . , F) is not included is expressed by the following expression.

[Math. 20]

|w_{f}^{H}a_{f,i}|≥1 . . . (*)

(f=1, . . . , F, i=1, . . . , N)

The optimization unit 120 may calculate the optimum value w*, by solving an optimization problem min_{{c_f,w_f}}(Σ_{f=1}^{F}Σⱼ₌₁^{M}|w_{f}^{H}b_{f,j}|²+Σ_{f=1}^{F}Σᵢ₌₁^{N}∧_{(f,i),c_f,i}(w_{f}^{H}a_{f,i})) relevant to the filter coefficient w and the discrete variable c₁, . . . , c_{F} instead of solving the optimization problem min_{w_1, . . . ,w_F}Σ_{f=1}^{F}Σⱼ₌₁^{M}|w_{f}^{H}b_{f,j}|² under the constraint condition (*). Here, C is an integer equal to or more than 1, c_{f,i} (f=1, . . . , F, i=1, . . . , N) is a discrete variable that has a value of 1, . . . , C, c_{f}=(c_{f,1}, . . . , c_{f,N}) (f=1, . . . , F) is a discrete variable that is defined by the discrete variable C_{f,1}, . . . , c_{f,N}, and a function ∧_{(f,i),c_f,i} (f=1, . . . , F, i=1, . . . , N) is a function relevant to a variable γ_{f,i} that is defined by the following expression (γ_{f,1}=w_{f}^{H}a_{f,i}).

$$\begin{matrix}[ Math . 21 ] & \\ {Λ}_{( f , i ) , {c}_{f , i}} ( {γ}_{f , i} ) = \{ \begin{matrix}0 ( R ( {γ}_{f , i} {e}^{- 2 π f ( {c}_{f , i} + 1 ) / 2 C} ) \geq 1 , \frac{2 π {c}_{f , i}}{C} \leq {∠γ}_{f , i} \leq \frac{2 π ( {c}_{f , i} + 1 )}{C} ) \\ ∞ ( otherwise )\end{matrix} & \end{matrix}$$

The optimization unit 120 for solving the optimization problem min_{{c_f,w_f}}(Σ_{f=1}^{F}Σⱼ₌₁^{M}|w_{f}^{H}b_{f,j}|²+Σ_{f=1}^{F}Σᵢ₌₁^{N}∧_{(f,i),c_f,i}(w_{f}^{H}a_{f,i})) will be described below with reference to FIG. 6 and FIG. 7. FIG. 6 is a block diagram showing the configuration of the optimization unit 120. FIG. 7 is a flowchart showing the behavior of the optimization unit 120. As shown in FIG. 6, the optimization unit 120 includes a candidate calculation unit 122 and an optimum value determination unit 123.

The behavior of the optimization unit 120 will be described with FIG. 7.

In S122, the candidate calculation unit 122 calculates a candidate w_{f}^{candidate}[(c_{f,1}, . . . , C_{f,N})] of the optimum value of the filter coefficient w_{f} for all values that the discrete variable (c_{f,1}, . . . , c_{f,N}) can have, for each frequency bin f, by the following expression.

$$\begin{matrix}[ Math . 22 ] & \\ {w}_{f}^{candidate} [ ( {c}_{f , 1} , … , {c}_{f , N} ) ] ← {arg min}_{{w}_{f}} ( {\sum }_{f = 1}^{M} {\vert {w}_{f}^{H} {b}_{f , j} \vert}^{2} + {\sum }_{i = 1}^{N} {Λ}_{( f , i ) , {c}_{f , i}} ( {w}_{f}^{H} {a}_{f , i} ) ) & \end{matrix}$$

In S123, the optimum value determination unit 123 adopts a candidate that is of the candidate w_{f}^{candidate}[(c_{f,1}, . . . , c_{f,N})] calculated in S122 and that minimizes the value of the cost function Σⱼ₌₁^{M}|w_{f}^{H}b_{f,j}|²+Σᵢ₌₁^{N}∧_{(f,i),c_f,i}(w_{f}^{H}a_{f,i}), as the optimum value wₜ.*, for each frequency bin f, and obtains the optimum value w* from w*={w₁*, . . . , W_{F}*}.

According to the embodiment of the present invention, it is possible to optimize the filter coefficient by solving the convex optimization problem equivalent to the non-convex optimization problem instead of solving the non-convex optimization problem.

<Supplement>

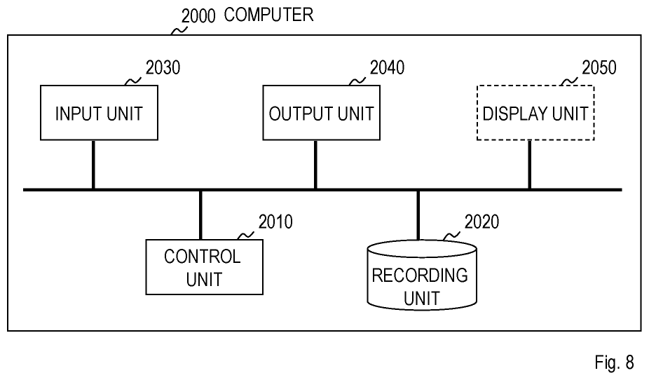

FIG. 8 is a diagram showing an example of the functional configuration of a computer that realizes the apparatuses described above. The processing in the apparatuses described above can be executed when a recording unit 2020 reads programs for causing a computer to function as the apparatuses described above and a control unit 2010, an input unit 2030, an output unit 2040 and the like to behave.

For example, as a single hardware entity, the apparatus in the present invention includes an input unit that can be connected with a keyboard and the like, an output unit that can be connected with a liquid crystal display and the like, a communication unit that can be connected with a communication device (for example, a communication cable) capable of communicating with the exterior of the hardware entity, a CPU (Central Processing Unit, a cache memory, a register and the like may be included), a RAM and a ROM that are memories, an external storage device that is a hard disk, and a bus that connects the input unit, the output unit, the communication unit, the CPU, the RAM, the ROM and the external storage device such that data can be exchanged. Further, as necessary, the hardware entity may be provided with a device (drive) that can perform reading and writing for a record medium such as a CD-ROM. As a physical entity including the hardware resources, there are a general-purpose computer and the like.

In the external storage device of the hardware entity, programs necessary for realizing the above functions, data necessary in the processing of the programs, and the like are stored (for example, the program may be stored in a ROM that is a read-only storage without being limited to the external storage device). Further, data and others obtained by the processing of the programs are appropriately stored in the RAM, the external storage device or the like.

In the hardware entity, the programs stored in the external storage device (or the ROM or the like) and the data necessary for the processing of the programs are read in the memory as necessary, and are appropriately interpreted, executed or processed by the CPU. As a result, the CPU realizes predetermined functions (the above component units expressed as the . . . unit, the . . . means and the like).

The present invention is not limited to the above-described embodiments, and modifications can be appropriately made without departing from the spirit of the present invention. Further, the processes described in the above embodiments do not need to be executed in a time-series manner in the order of the descriptions, and may be executed in parallel or individually, depending on the processing capacities of the devices that execute the processes or as necessary.

In the case where the processing functions in the hardware entity (the apparatus in the present invention) described in the above embodiments are realized by a computer as described above, the processing contents of the functions to be included in the hardware entity are described by programs. Then, the programs are executed by the computer, and thereby, the processing functions in the above hardware entity are realized on the computer.

The programs describing the processing contents can be recorded in a computer-readable record medium. As the computer-readable record medium, for example, a magnetic record device, an optical disk, a magneto-optical record medium, a semiconductor memory and others may be used. Specifically, for example, a hard disk device, a flexible disk, a magnetic tape or the like can be used as the magnetic record device, a DVD (Digital Versatile Disc), a DVD-RAM (Random Access Memory), a CD-ROM (Compact Disc Read Only Memory), a CD-R (Readable)/RW (ReWritable) or the like can be used as the optical disk, an MO (Magneto-Optical disc) or the like can be used as the magneto-optical record medium, and an EEP-ROM (Electronically Erasable and Programmable-Read Only Memory) or the like can be used as the semiconductor memory.

For example, the distribution of the programs is performed by sale, transfer, lending or the like of a portable record medium such as a DVD or CD-ROM in which the programs are recorded. Furthermore, the programs may be distributed by storing the programs in a storage device of a server computer and transmitting the programs from the server computer to another computer through a network.

For example, the computer that executes the programs, first, once stores the programs recorded in the portable record medium or the programs transmitted from the server computer, in its own storage device. Then, at the time of the execution of the processing, the computer reads a program stored in its own storage device, and executes a process in accordance with the read program. Further, as another form of the execution of the programs, the computer may read a program directly from the portable record medium, and may execute a process in accordance with the program. Furthermore, whenever a program is transmitted from the server computer to the computer, the computer may execute a process in accordance with the received program. Further, the above-described processes may be executed by a so-called ASP (Application Service Provider) service in which the processing functions are realized by only execution instruction and result acquisition, without the transmission of the programs from the server computer to the computer. The program in the form includes information that is supplied for the processing by an electronic computer and that is similar to the program (for example, data that is not a direct command to the computer but has a property of prescribing the processing by the computer).

In the form, the hardware entity is configured by executing predetermined programs on the computer, but at least some of the processing contents may be realized in hardware.

The above description of the embodiment of the present invention has been presented for the purpose of exemplification and description. It is not intended to be exhaustive, and it is not intended to limit the invention to the disclosed strict form. Modifications and variations can be made from the above disclosure. The embodiments are selected and expressed, such that the best exemplification of the principle of the present invention is provided and such that a person skilled in the art can use the present invention as various embodiments suitable for deliberated actual use or can use the present invention while adding various modifications. All modifications and variations fall within the scope of the present invention that is determined by the attached claims interpreted based on a range given justly, lawfully and fairly.

1. A filter coefficient optimization apparatus including an optimization unit that calculates an optimum value w* of a filter coefficient w={w₁, . . . , w_{F}} (w_{f} (f=1, . . . , F, F is an integer equal to or more than 1) is a filter coefficient of a frequency bin f) of a beamformer that emphasizes sound (hereinafter referred to as target sound) from D sound sources (hereinafter referred to as a sound source 1, . . . , a sound source D),
D being an integer equal to or more than 1,
R_{f}(f=1, . . . , F) being a spatial correlation matrix for sound other than the target sound relevant to the frequency bin f, L_{MV_f}(w_{f})=w_{f}^{H}R_{f}w_{f} (f=1, . . . , F) being a cost function relevant to a filter coefficient w_{f},
the optimization unit calculating the optimum value w* based on an optimization problem min_{w_1, . . . ,W_F}Σ_{f=1}^{F}L_{MV_f}(w_{f}) relevant to the filter coefficient w under a predetermined constraint condition,
the predetermined constraint condition not including a constraint relevant to a phase of the filter coefficient w_{f} (f=1, . . . , F).

2. The filter coefficient optimization apparatus according to claim 1, wherein:
θd (d=1, . . . , D) is an angular direction in which a sound source d exists, and a_{f,d}(f=1, . . . , F, d=1, . . . , D) is an array manifold vector in the frequency bin f corresponding to a sound wave that comes from the angular direction Od, the sound wave being a plane wave; and
the predetermined constraint condition is expressed by the following expression:
[Math. 23]

|w_{f}^{H}a_{f,d}|=1
(f=1, F, . . . ,d=1, D).

3. The filter coefficient optimization apparatus according to claim 1, wherein:
θd (d=1, . . . , D) is an angular direction in which a sound source d exists, and a_{f,d}(f=1, . . . , F, d=1, D) is an array manifold vector in the frequency bin f corresponding to a sound wave that comes from the angular direction Od, the sound wave being a plane wave; and
the predetermined constraint condition is expressed by the following expression:
[Math. 24]

|w_{f}^{H}a_{f,d}|≥1.
(f=1, F, d=1, D).

4. The filter coefficient optimization apparatus according to claim 3, wherein:
C is an integer equal to or more than 1, C_{f,d}(f=1, . . . , F, d=1, . . . , D) is a discrete variable that has a value of 1, . . . , C, c_{f}=(c_{f,i}, . . . , c_{f,D}) (f=1, F) is a discrete variable that is defined by a discrete variable c_{f,i}, . . . , c_{f,D}, and ∧_{(f,d),c_f,d}(f=1, . . . , F, d=1, . . . , D) is a function relevant to a variable γ_{f,d} that is defined by the following expression (γ_{f,d}=w_{f}^{H}a_{f,d}):
$$\begin{matrix}[ Math . 25 ] & \\ {Λ}_{( f , d ) , {c}_{f , d}} ( {γ}_{f , d} ) = \{ \begin{matrix}0 ( R ( {γ}_{f , d} {e}^{- 2 π j ( {c}_{f , d} + 1 ) / 2 C} ) \geq 1 , \frac{2 π {c}_{f , d}}{C} \leq {∠γ}_{f , d} \leq \frac{2 π ( {c}_{f , d} + 1 )}{C} ) \\ ∞ ( otherwise )\end{matrix} ; & \end{matrix}$$
and
the optimization unit calculates the optimum value w*, by solving an optimization problem min_{{c_f,w_f}}(Σ_{f=1}^{F}L_{MV_f}(w_{f})+Σ_{f=1}^{F}Σ_{d=1}^{D}∧_{(f,d),c_f,d}(w_{f}^{H}a_{f,d})) relevant to the filter coefficient w and the discrete variable c₁, . . . , C_{F} instead of solving the optimization problem min_{w_1, . . . ,W_F}Σ_{f=1}^{F}L_{MV_f}(w_{f}).

5. The filter coefficient optimization apparatus according to claim 4, wherein
the optimization unit includes a candidate calculation unit configured to calculate a candidate w_{f}^{candidate}[(c_{f,i}, . . . , c_{f,D})] of the optimum value of the filter coefficient w_{f} for all values that the discrete variable (c_{f,1}, . . . , c_{f,D}) can have, for each frequency bin f, by the following expression:
$$\begin{matrix}[ Math . 26 ] & \\ {w}_{f}^{candidate} [ ( {c}_{f , 1} , … , {c}_{f , D} ) ] ← {arg min}_{{w}_{f}} ( {L}_{{MV}_{f}} ( {w}_{f} ) + {\sum }_{d = 1}^{D} {Λ}_{( f , d ) , {c}_{f , d}} ( {w}_{f}^{H} {a}_{f , d} ) ) & \end{matrix}$$
and
an optimum value determination unit configured to adopt a candidate that is of the candidate w_{f}^{candidate}[(c_{f,1}, . . . , c_{f,D})] and that minimizes a value of a cost function L_{MV_f}(w_{f})+Σ_{d=1}^{D}∧_{(f,d),c_f,d}(w_{f}^{H}a_{f,d}), as an optimum value w_{f}* of the filter coefficient w_{f}, for the frequency bin f, and configured to obtain the optimum value w* from w*={Cw₁*, . . . , w_{F}*}.

6. A latent variable optimization apparatus including an optimization unit that calculates an optimum value ˜w* of a latent variable ˜w based on an optimization problem min_{˜w}(L_{convex}(˜w)+Σ_{d=1}^{D}L_{d}(˜w)) relevant to the latent variable ˜w,
L_{convex} being a strongly convex function relevant to the latent variable ˜w, L_{d}(d=1, . . . , D, D is an integer equal to or more than 1) being a function relevant to the latent variable ˜w,
C being an integer equal to or more than 1, S_{d,1}, . . . , S_{d,C}(d=1, D) being a region that is obtained by dividing a domain of the function L_{d} into C closed convex sets, ∧_{d,c}(d=1, . . . , D, c=1, . . . , C) being a convex function that is defined on the region S_{d,c} and that approximates the function L_{d}, c_{d}(d=1, . . . , D) being a discrete variable that has a value of 1, C,
the optimization unit calculating the optimum value ˜w* by solving an optimization problem min_{c_1, . . . ,c_D}(min_{˜w}(L_{convex}(˜w)+Σ_{d=1}^{D}∧_{d,c_d}(˜w))) relevant to the latent variable ˜w and the discrete variable c₁, . . . , c_{D} instead of solving the optimization problem min_{˜w}(L_{convex}(˜w)+Σ_{d=1}^{D}L_{d}(˜w)).

7. The latent variable optimization apparatus according to claim 6, wherein
the optimization unit includes
a candidate calculation unit configured to calculate a candidate ˜w^{candidate}[(c₁, . . . , c_{D})] of the optimum value of the latent variable ˜w for all values that the discrete variable (c₁, . . . , c_{D}) can have, by the following expression:
$$\begin{matrix}[ Math . 27 ] & \\ {\tilde{w}}^{candidate} [ ( {c}_{1} , … , {c}_{D} ) ] ← {arg min}_{\tilde{w}} ( {L}_{convex} ( \tilde{w} ) + {\sum }_{d = 1}^{D} {Λ}_{d , {c}_{d}} ( \tilde{w} ) ) & \end{matrix}$$
and
an optimum value determination unit configured to adopt a candidate that is of the candidate ˜w^{candidate}[(c₁, . . . , c_{D})] and that minimizes a value of a cost function L_{convex}(˜w)+Σ_{d=1}^{D}∧_{d,c_d}(˜w), as the optimum value ˜w*.

8. A filter coefficient optimization method including an optimization step in which a filter coefficient optimization apparatus calculates an optimum value w* of a filter coefficient w={w₁, . . . , w_{F}} (w_{f} (f=1, . . . , F, F is an integer equal to or more than 1) is a filter coefficient of a frequency bin f) of a beamformer that emphasizes sound (hereinafter referred to as target sound) from D sound sources (hereinafter referred to as a sound source 1, . . . , a sound source D),
D being an integer equal to or more than 1,
R_{f}(f=1, . . . , F) being a spatial correlation matrix for sound other than the target sound relevant to the frequency bin f, L_{MV_f}(w_{f})=w_{f}^{H}R_{f}w_{f}(f=1, . . . , F) being a cost function relevant to a filter coefficient w_{f},
the optimization step being a step of calculating the optimum value w* based on an optimization problem min_{w_1, . . . , W_F}Σ_{f=1}^{F}L_{MV_f}(w_{f}) relevant to the filter coefficient w under a predetermined constraint condition,
the predetermined constraint condition not including a constraint relevant to a phase of the filter coefficient w_{f} (f=1, . . . , F).

9. A latent variable optimization method including an optimization step in which a latent variable optimization apparatus calculates an optimum value ˜w* of a latent variable ˜w based on an optimization problem min_{˜w}(L_{convex}(˜w)+Σ_{d=1}^{D}L_{d}(˜w)) relevant to the latent variable ˜w,
L_{convex} being a strongly convex function relevant to the latent variable ˜w, L_{d} (d=1, . . . , D, D is an integer equal to or more than 1) being a function relevant to the latent variable ˜w,
C being an integer equal to or more than 1, S_{d,1}, . . . , S_{d,C}(d=1, . . . , D) being a region that is obtained by dividing a domain of the function L_{d} into C closed convex sets, ∧_{d,c}(d=1, . . . , D, c=1, . . . , C) being a convex function that is defined on the region S_{d,c} and that approximates the function L_{d}, ca (d=1, D) being a discrete variable that has a value of 1, C,
the optimization step being a step of calculating the optimum value ˜w* by solving an optimization problem min_{c_1, . . . , c_D}(min_{˜w}(L_{convex}(˜w)+Σ_{d=1}^{D}∧_{d,c_d}(˜w))) relevant to the latent variable ˜w and the discrete variable c₁, . . . , C_{D} instead of solving the optimization problem min_{˜w}(L_{convex}(˜w)+Σ_{d=1}^{D}L_{d}(˜w)).

10. A non-transitory computer-readable recording medium storing a program that causes a computer to function as the filter coefficient optimization apparatus according to claim 1.

11. A non-transitory computer-readable recording medium storing a program that causes a computer to function as the latent variable optimization apparatus according to claim 6.
